(19) United States
(12) Patent Application Publication
(10) Pub. No.: US 2010/0082155 A1
(43) Pub. Date: Apr. 1, 2010

(54) APPARATUS FOR MONITORING BUILDING STATUS OF CAVITY FRAME

(75) Inventors: Seong-youb Chung, Gwangju-si (KR); Jin-il Hong, Cheongju-si (KR); Ji-hye Cha, Daejeon (KR); Young-jun Park, Daejeon (KR); Jae-hoon Kim, Daejeon (KR)

Correspondence Address: HARNESS, DICKEY & PIERCE, P.L.C., P.O. BOX 828, BLOOMFIELD HILLS, MI, 48303, US

(73) Assignee: SAMSUNG HEAVY IND. CO., LTD, Geoje-si, Gyeongsangnam-do (KR)

(21) Appl. No.: 12/442,324

(22) PCT Filed: Sep. 20, 2007
(86) PCT No.: PCT/KR07/04614

§ 371 Date: Mar. 20, 2009

(30) Foreign Application Priority Data
Sep. 21, 2006 (KR) 10-2006-0091801

(51) Int. Cl. G06F 19/00

(52) U.S. Cl. 700/245

(57) ABSTRACT

Disclosed is an apparatus for monitoring a building status achieved during building a cavity frame such as an internal freight warehouse of a cargo. The apparatus for monitoring a building status of a cavity frame includes a portable computer, a central host computer, and an indoor global positioning system. The portable computer remotely accesses the central host computer and downloads information on a work schedule, and the central host computer receives information on problems during works from the portable computer. The indoor global positioning system remotely accesses the central host computer to transmit positional information of a working robot in the cavity frame. The central host computer then transmits, to the working robot, an instruction to perform a corresponding work at a position of the working robot.

### TECHNICAL FIELD

The present invention relates to an apparatus for monitoring a building status achieved during building a cavity frame, and more particular, relates to an apparatus for monitoring work status by way of remotely exchanging information with a central host computer using an indoor global positioning system, during a worker is working in a workplace such as an internal freight warehouse of a cargo.

### BACKGROUND ART

In general, when a worker is working in a freight warehouse of a cargo during building, in order to indicate a work status achieved in such cavity frame, a work manager marks a work progress chart when daily works end.

For example, FIG. 1 represents a work progress chart, which indicates the work status performed in the cavity frame, according to a prior art. As shown in FIG. 1, divided boxes 10, 20, and 30 represent the work types, and black regions 10a, 10b, and 10c in the boxes represent the amount of work progress.

There is a drawback in that the worker needs to go to a position where the work progress chart is located and confirms the work process chart with his/her eyes. In addition, the worker cannot record the problems encountered during the works in the work progress chart, and cannot confirm the current work status. Furthermore, when the worker does not faithfully record the problems, the works may be different from real works.

### DISCLOSURE OF INVENTION

### Technical Problem

Therefore, it is an object of the invention to provide an apparatus for monitoring a building status achieved during building a cavity frame by way of remotely exchanging information with a central host computer using an indoor global positioning system, during a worker is working in the cavity frame, thereby monitoring work progress.

### Technical Solution

According to an aspect of the invention, it is characterized in that an apparatus for monitoring a building status achieved during building a cavity frame by a working robot includes: a portable computer that remotely accesses a central host computer and downloads information on a work schedule; the central host computer that receives information on problems encountered during building a cavity frame from the portable computer; and an indoor global positioning system that remotely accesses the central host computer to transmit information on a position of the working robot in the cavity frame, wherein the central host computer transmits, to the working robot, an instruction to perform a corresponding work at the position of the working robot.

### Advantageous Effects

According to the apparatus for monitoring a building status achieved during building a cavity frame of the invention, the worker can remotely access the central host computer using the portable computer and download the work schedule. Therefore, the worker can rapidly meet the changes in the work condition. As a result, the worker can rapidly grasp and meet the problems occurred during the works.

### BRIEF DESCRIPTION OF THE DRAWINGS

FIG. 1 is a work progress chart, which indicates a work status performed in a cavity frame, according to a prior art;

FIG. 2 is a block diagram showing an apparatus for monitoring a building status achieved during building a cavity frame according to an embodiment of the invention; and

FIG. 3 is a diagram showing the configuration of an indoor global positioning system according to an embodiment of the invention.

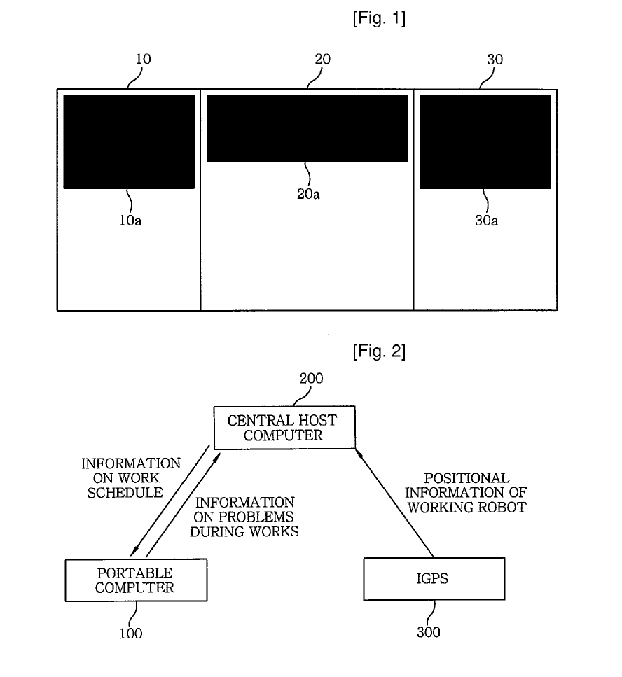

### BEST MODE FOR CARRYING OUT THE INVENTION

The present invention provides an apparatus for monitoring a building status achieved during building a cavity frame by a working robot, which includes a portable computer that remotely accesses a central host computer and downloads information on a work schedule; the central host computer that receives information on problems encountered during building a cavity frame from the portable computer; and an indoor global positioning system that remotely accesses the central host computer to transmit information on a position of the working robot in the cavity frame, wherein the central host computer transmits, to the working robot, an instruction to perform a corresponding work at the position of the working robot.

An exemplary embodiment of the invention will now be described in detail with reference to the accompanying drawings.

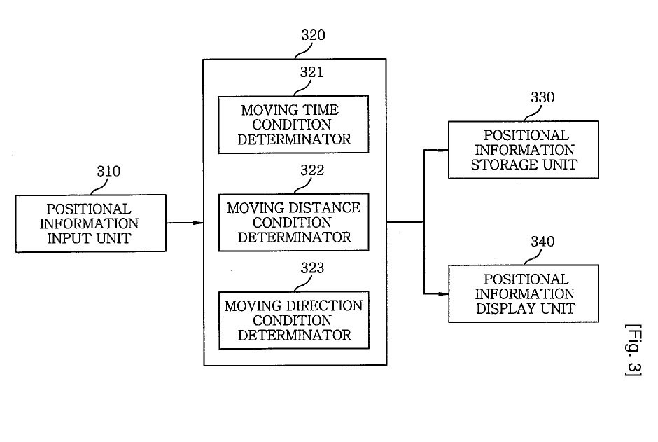

FIG. 2 is a block diagram showing an apparatus for monitoring a building status of a cavity frame according to an embodiment of the invention. As shown in FIG. 2, the apparatus for monitoring a building status achieved during building a cavity frame of a cargo according to an embodiment of the invention includes a portable computer 100, a central host computer 200, and an indoor global positioning system (hereinafter, referred to as “IGPS”) 300.

The portable computer 100 remotely accesses the central host computer 200 and downloads information on a work schedule therefrom.

The central host computer 200 receives information on problems encountered during works from the portable computer 100. At this time, the central host computer 200 transmits, to a working robot (not shown) disposed in the cavity frame of the cargo during building, an instruction to perform a corresponding work at a position of the working robot.

The IGPS 300 remotely accesses the central host computer 200 and transmits the positional information of the working robot in the cavity frame.

In the prior art, a worker needs to check the work schedule in detail in the cavity frame. In contrast, according to the embodiment of the invention, a worker can rapidly receive the information on the work schedule from the central host computer 200. Accordingly, the worker can achieve the position of the working robot in real time, and can rapidly meet the changing work conditions.

FIG. 3 is a diagram showing the configuration of the IGPS according to an embodiment of the invention. As shown in FIG. 3, the IGPS includes a positional information input unit 310, a positional information selection unit 320, a positional information storage unit 330, and a positional information display unit 340. In addition, the positional information selection unit 320 includes a moving time condition determinator 321, a moving distance condition determinator 322, and a moving direction condition determinator 323.

The positional information input unit 310 acquires the positional information of the working robot as similar as conventionally acquiring positional information thereof from a GPS (Global Positioning System) satellite (not shown). In this connection, a technology that calculates a relative three-dimensional coordinate of a specific location using an indoor GPS is disclosed in U.S. Pat. No. 6,501,543, the disclosure of which is incorporated herein by reference.

The positional information selection unit 320 determines whether or not to select the acquired positional information of the working robot on the basis of the determination results of the moving time condition determinator 321 to determine a condition on a moving time of the working robot, the moving distance condition determinator 322 to determine a condition on a moving distance of the working robot, and the moving direction condition determinator 323 to determine a condition on a moving direction of the working robot. If the positional information selection unit 320 determines to select the positional information, the selected positional information is output through the positional information display unit 340.

The positional information storage unit 330 stores the positional information of the working robot selected by the positional information selection unit 320, for example, in a storage device, such as a database, in a file format.

The positional information display unit 340 includes a display, and displays, on a screen of the display, the positional information of the working robot selected by the positional information selection unit 320, such that a worker can view the positional information of the working robot on the screen.

The positional information selection unit 320, the positional information storage unit 330, and the positional information display unit 340 function independently and simultaneously. That is, when one unit is operating, other units are operating, specifically, three components are operating simultaneously. Therefore, it is possible to reduce a time required for acquiring the positional information of the working robot.

Although the apparatus for monitoring a building status performed during building a cavity frame has been described in connection with the embodiment by way of the accompanying drawings, it should be noted that the embodiment is not limitative, but illustrative. It will be apparent to those skilled in the art that various modifications and changes can be made without departing from the scope of the invention.

1. An apparatus for monitoring a building status achieved during building a cavity frame using a working robot, the apparatus comprising:
a portable computer that remotely accesses a central host computer and downloads information on a work schedule;
the central host computer that receives information on problems encountered during building a cavity frame from the portable computer; and
an indoor global positioning system that remotely accesses the central host computer to transmit information on a position of the working robot in the cavity frame,
wherein the central host computer transmits, to the working robot, an instruction to perform a corresponding work at the position of the working robot.

2. The apparatus of claim 1, wherein the indoor global positioning system includes:
a positional information input unit that acquires the positional information of the working robot;
a positional information selection unit that determines whether or not to select the acquired positional information of the working robot, and outputs the selected positional information;
a positional information storage unit that stores therein the positional information of the working robot selected by the positional information selection unit; and
a positional information display unit that displays, on a screen thereof, the positional information of the working robot selected by and provided from the positional information selection unit.

3. The apparatus of claim 2, wherein the positional information selection unit includes:
a moving time condition determinator that determines a condition on a moving time of the working robot;
a moving distance condition determinator that determines a condition on a moving distance of the working robot; and
a moving direction condition determinator that determines a condition on a moving direction of the working robot.
